(19) United States
(12) Patent Application Publication
(10) Pub. No.: US 2012/0171904 A1
(43) Pub. Date: Jul. 5, 2012

(54) BURNER ASSEMBLY FOR A LAMP

(76) Inventors: SHYH MING CHEN, Taipei County (TW); Xiang Lin You, Taipei County (TW)

(21) Appl. No.: 12/984,561

(22) Filed: Jan. 4, 2011

(51) Int. Cl. H01R 33/22

(52) U.S. Cl. 439/661

(57) ABSTRACT

A burner assembly of a lamp includes a burner and at least one flexible conductor. The burner has a junction portion and a projection portion. The junction portion has an outer thread on a peripheral thereof and a open hole on a top thereof for arranging a first electrode. At least one through hole is formed to the junction portion. The flexible conductor has a positioning head on an end thereof. The positioning head severs to be a second electrode and is elastically protruded from the at least one through hole so as to be electrically connected to a lamp holder firmly.

### FIELD OF THE INVENTION

The present invention relates to a lamp burner, and particular to a lamp burner assembly for a lamp or LED.

### DESCRIPTION OF THE PRIOR ART

Lamps such as colorful neon lamps, lamps projecting on advertisement board, and lights or desk lights in the house are all widely used and requisite in our life.

The conventional lamp bulb and the fast-developing light emitting diode (LED) are most common illumination devices. The design of the illumination device is different for various functions and purposes of illumination. Lamps nowadays are not only a light source any more, additional values are also well concerned in modern designs.

Referring to FIG. 1, a conventional lamp assembly is illustrated. A bright lamp will generate more heat which could cause damages to the electronic parts of the lamp. Therefore, a lamp 10 has a plurality of fin 101 for heat dissipation. Heat dissipation can be hastened by the increase of surface area. However, for the concern of the power connection to a lamp and an outer thread for connection, the complexity of manufacture is different by different material and assembly. Additional heat dissipation module will also cause higher cost, working-hour, and defective fraction.

Referring to FIG. 2, the assembly of the prior art is to assemble the burner 10 and a dissipating shield 20 consisting of a plurality of fin separately, then put together the complete burner 10 and dissipating shield 20. However, the gluing of the two parts is still time-consuming. The connector made of metal has an oxidization problem which could cause further connection problem. Also, cost for metal is also higher. Therefore, a new design is imperious.

A Taiwan patent of no. M330419 discloses a ceramic burner assembly. The burner has a ceramic cylinder body having an outer thread on a peripheral thereof and a groove formed to the outer thread. A terminal is received in the groove and partially protruded from the outer thread. An end of the terminal is electrically connected to a filament.

However, the groove on the integral ceramic cylinder body will weaken the intensity of the whole structure. Damage to the assembly is easily happened under collision or temperature fluctuation. The terminal protruding from the groove could have a contact problem due to mechanical tolerance or abrasion.

### SUMMARY OF THE PRESENT INVENTION

Accordingly, the primary object of the present invention is to provide a lamp burner made of insulated material. The shaping of the burner is fast and the precision of the engagement is good. An oxidation problem can be avoided so as to improve the whole manufacture and yield.

The various objects and advantages of the present invention will be more readily understood from the following detailed description when read in conjunction with the appended drawing.

### BRIEF DESCRIPTION OF THE DRAWINGS

FIG. 1 is a schematic view showing a prior art.

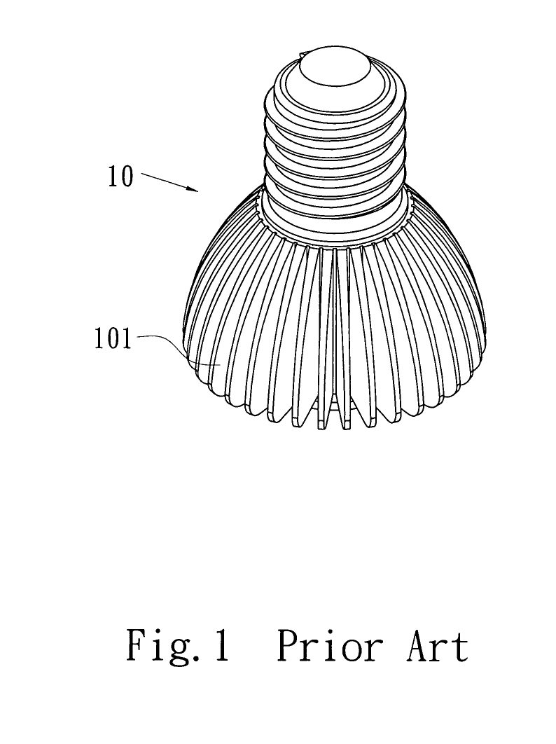

FIG. 2 is a schematic view showing a assembly of the prior art.

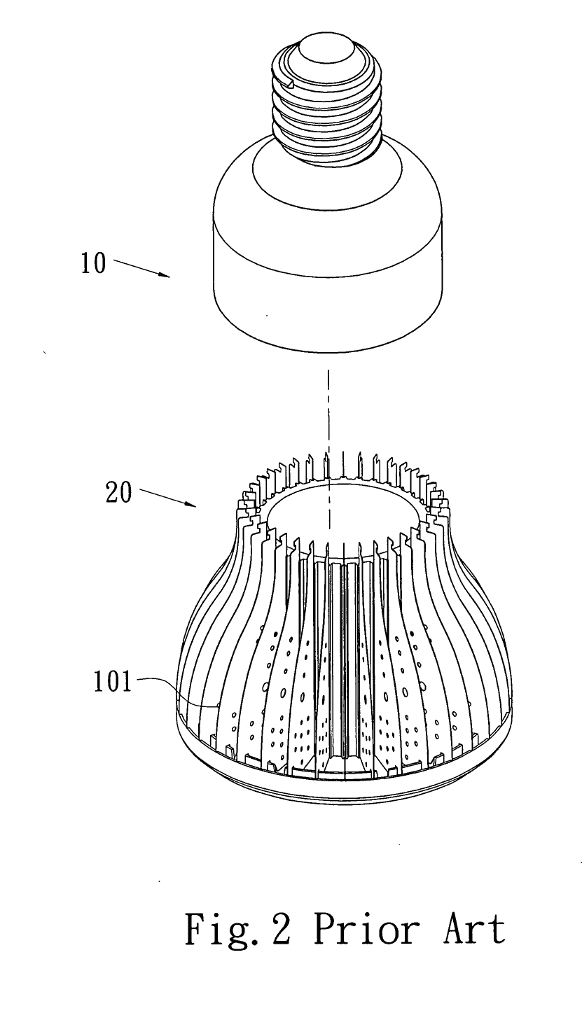

FIG. 3 is an exploded view showing a preferable embodiment of the present invention.

FIG. 4 is a side view of the preferable embodiment of the present invention.

FIG. 5 is a cross-section view showing the assembly of the preferable embodiment of the present invention.

FIG. 6 is a cross-section view of the preferable embodiment of the present invention.

FIG. 7 is a cross-section view showing another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

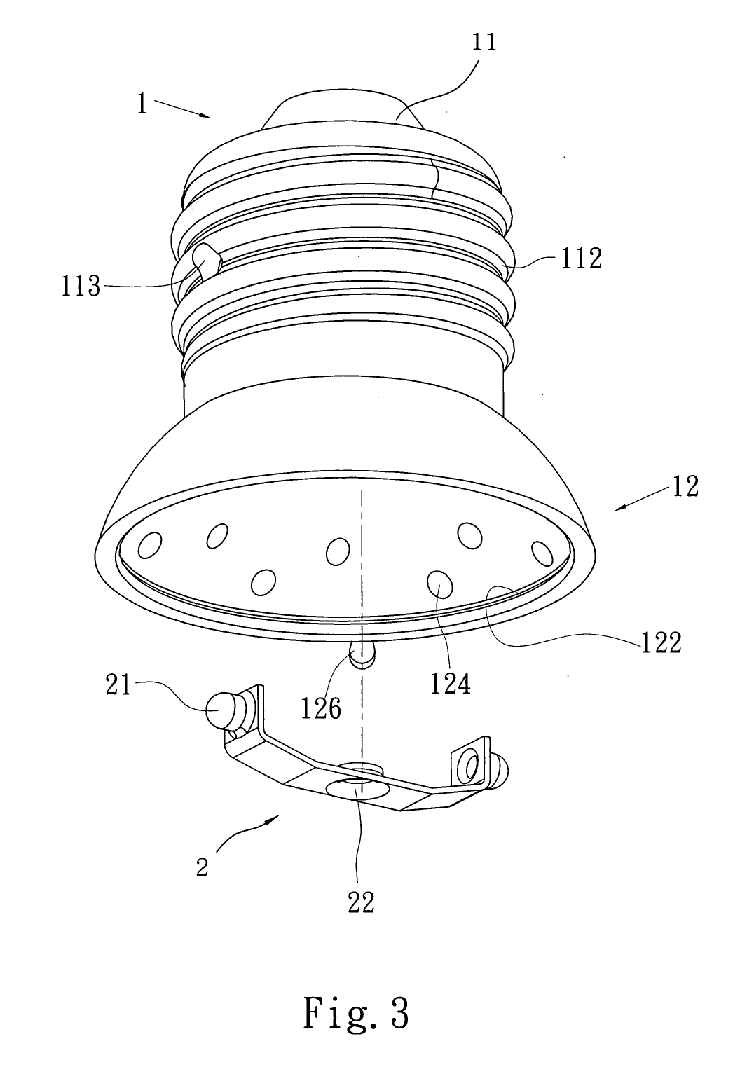

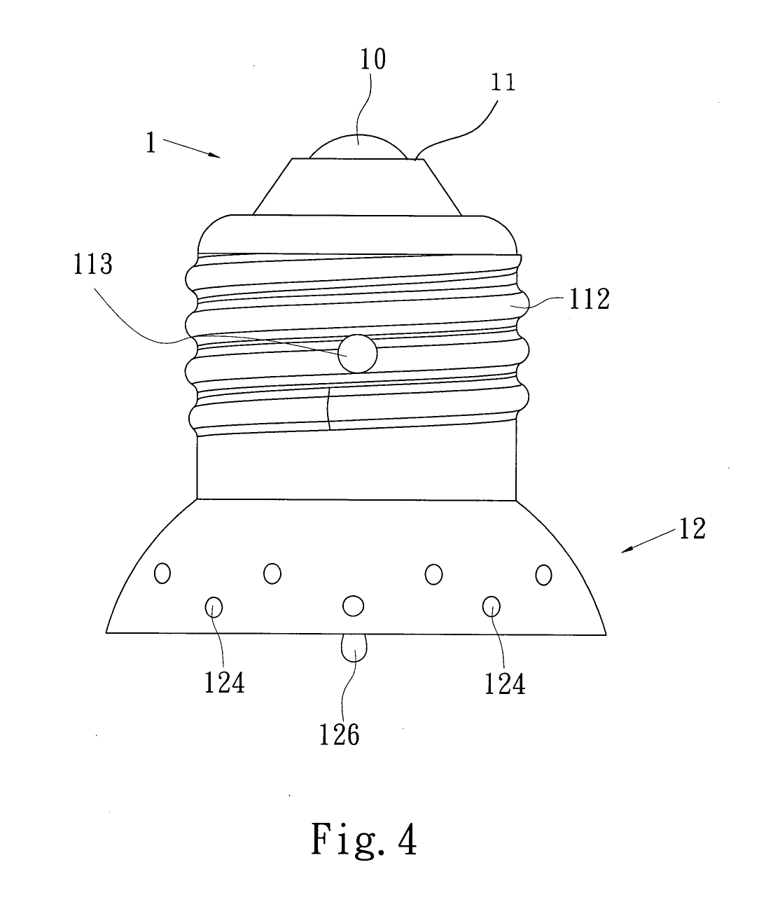

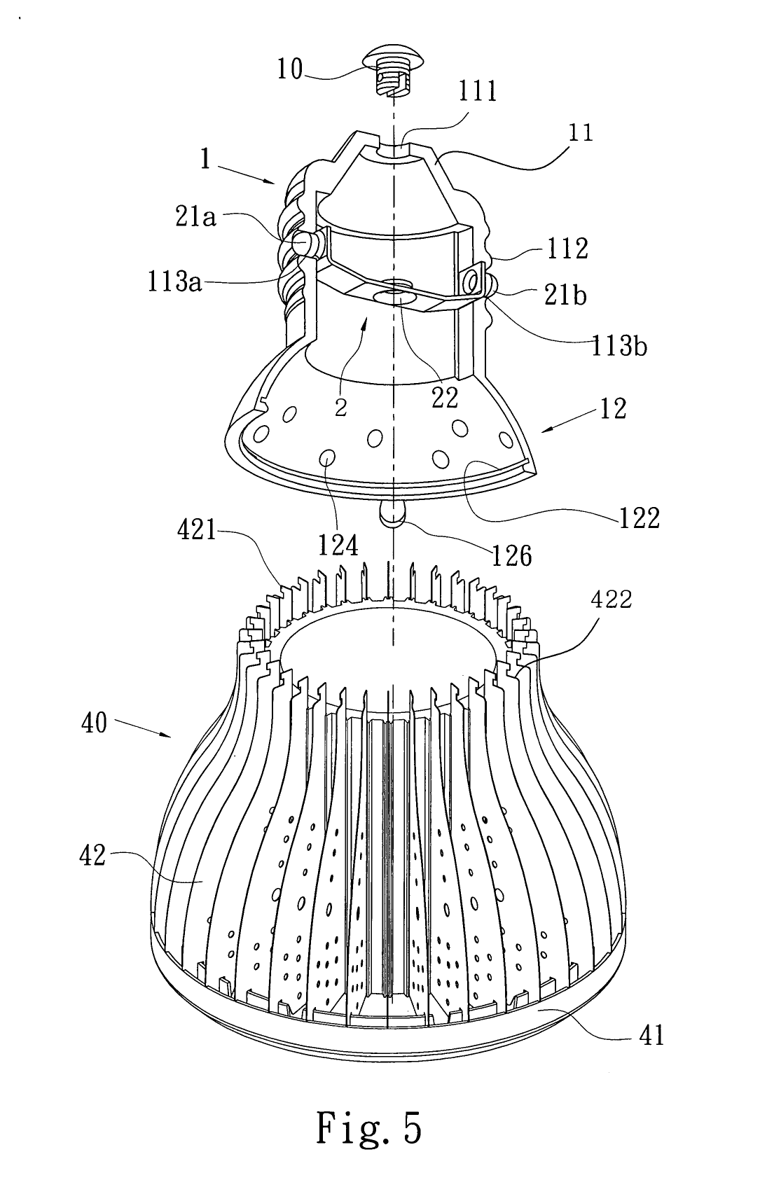

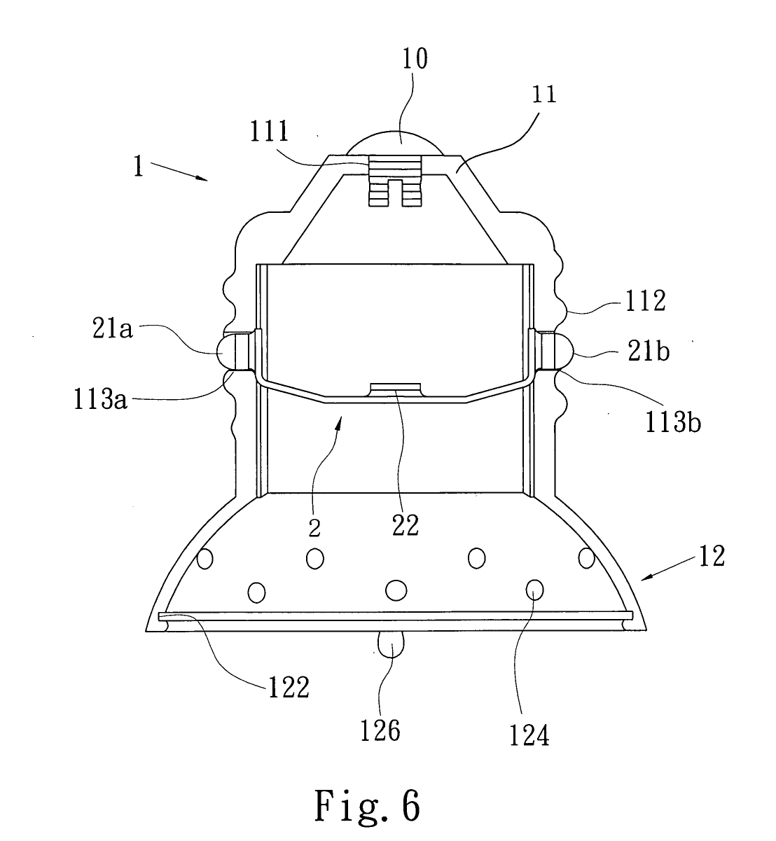

Referring to FIGS. 3 and 4, a preferable embodiment according to the present invention is illustrated. A burner assembly of the embodiment is a cylinder. The burner 1 is made of an insulated material. The insulated material can be plastic, bakelite, ceramic, or other material. The burner 1 includes a junction portion 11 and a projection portion 12. The junction portion 11 has an open hole 111 on a top thereof (shown in FIG. 5). A first electrode 10 is screwed into the open hole 111. The first electrode 10 is a bolt screwed into the open hole 111. One end of the bolt is protruded outside the burner 1 for receiving power, and the other end is electrically connected to lamp through a power code (not shown) so that the lamp is electrically connected to the first electrode 10 (such as a positive electrode). An outer thread 112 is formed to an outer peripheral of the junction portion 11 for being screwed into a lamp holder (not shown). The outer thread 112 serves to ground and position. The outer thread 112 further has at least one through hole 113 on a root or crest thereof. In the present embodiment, through holes 113a and 113b are formed to opposite roots of the outer thread 112 as shown in FIG. 5. A bowl open is formed to an end of the projection portion 12 and ventholes 124 are formed around the peripheral for heat dissipation. A flexible conductor 2 is arranged inside the junction portion 11 of the burner 1. Two ends of the flexible conductor 2 have a positioning head 21a and 21b respectively. The positioning heads are formed as a dome or an arc. The flexible conductor 2 is arranged inside the burner 1 with two positioning heads inserting and elastically protruding from the through holes 113a and 113b as shown in FIG. 5. The positioning heads 21a and 21b are elastically protruded from the surface of the outer thread 112 as contact points. While the burner 1 is screwed into a lamp holder, the burner 1 can be grounded by the contact of the positioning head 21 with the lamp holder. The positioning head 21 serves to be a second electrode (such as a negative electrode) opposite to the first electrode 10 so that a power loop is formed. Referring to FIGS. 5 and 6, a round groove 122 is formed to an inner wall of a bottom edge of the projection portion 12. A heat dissipation module 40 includes a plurality of fin 42 for dissipating heat of a lamp (not shown) inside a frame 41 of the heat dissipation module 40. A fitting portion 421 slightly wider than the open of the projection portion 12 is formed to ends of the plurality of fin 42, and a shoulder portion 422 is formed below the fitting portion 421. The fitting portion 421 can be inserted into the groove 122 with the shoulder portion 422 being against the open of the projection portion 12. Therefore, the heat dissipation module 40 can be easily and firmly installed to the burner 1. Moreover, a positioning hole 22 is formed to a center of the flexible conductor 2 so as to receiving the heat dissipation module 40 and lamp device (not shown) inside the heat dissipation module 40.

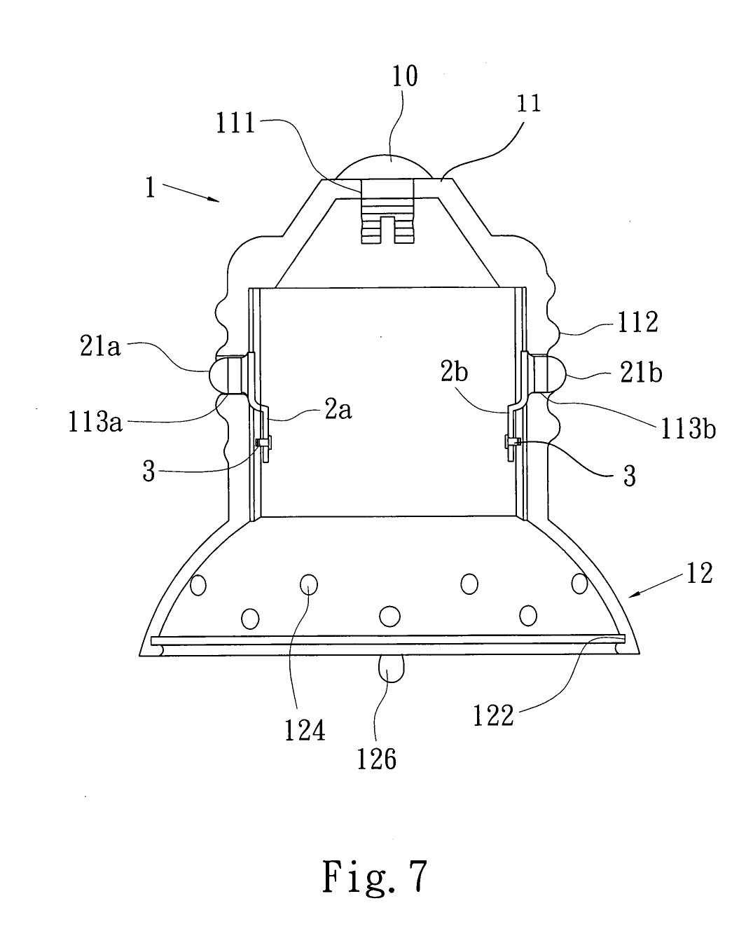

Referring to FIG. 7, another embodiment of the present invention is illustrated. Just like the above embodiment, however, the embodiment has two flexible conductors 2a and 2b having positioning heads 21a and 21b respectively. The two positioning heads are inserted and elastically protruded from through holes 113a and 113b of the burner 1. The positioning heads 21a and 21b are elastically protruded from the surface of the outer thread 112 as contact points. The other ends of the two flexible conductors 2a and 2b are fixed to an inner wall of the burner 1 by bolts 3.

Referring to FIGS. 5, 6, and 7, at least one stopper 126 is formed to the bottom edge of the projection portion 12. The stopper 126 serves to being inserted between two fins 42 so as to prevent an improper relative rotation between the burner 1 and the heat dissipation module 40 which could cause twist and damage to the wiring.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A burner assembly for a lamp comprising:
a burner having a junction portion and a projection portion; the junction portion having a open hole on a top thereof for receiving a wire conducted power to a first electrode thereof; an outer peripheral of the junction portion having an outer thread; the outer thread having at least one through hole; and
a flexible conductor being arranged inside the junction portion; at least one end of the flexible conductor having an positioning head which is a contact point of a second electrode; the positioning head being elastically protruded from the through hole and the outer thread.

2. A The burner assembly for a lamp as claimed in claim 1, wherein the burner is made of an insulated material.

3. A The burner assembly for a lamp as claimed in claim 2, wherein the burner is made of one of plastic, bakelite, or ceramic material.

4. A The burner assembly for a lamp as claimed in claim 1, wherein a plurality of venthole is formed to a peripheral of the projection portion.

5. A The burner assembly for a lamp as claimed in claim 1, wherein a round groove is formed to an inner wall of a bottom edge of the projection portion; a heat dissipation module includes a plurality of fin; a fitting portion slightly wider than an open of the projection portion is formed to ends of the plurality of fin, and a shoulder portion is formed below the fitting portion; the fitting portion can be inserted into the groove with the shoulder portion being against the open of the projection portion.

6. The burner assembly for a lamp as claimed in claim 1, wherein the first electrode is screwed into the open hole for connecting a wire supplying power.

7. A The burner assembly for a lamp as claimed in claim 6, wherein the first electrode is a bolt screwed into the open hole of the junction portion; an end of the bolt is protruded from the top of the burner assembly for conducting power, and the other end thereof is connected to a lamp inside through a wire.

8. A The burner assembly for a lamp as claimed in claim 1, wherein the outer thread has a plurality of root and crest.

9. A The burner assembly for a lamp as claimed in claim 8, wherein the through hole is formed to a crest of the outer thread.

10. A The burner assembly for a lamp y as claimed in claim 8, wherein the through hole is formed to a root of the outer thread.

11. A The burner assembly for a lamp as claimed in claim 1, wherein the flexible conductor is made of metal.

12. A The burner assembly for a lamp as claimed in claim 1, wherein a positioning hole is formed to a center of the flexible conductor for arranging a heat dissipation module and a lamp.

13. A The burner assembly for a lamp for a lamp as claimed in claim 1, wherein the positioning head of the flexible conductor is formed as one of a dome or an arc.

14. A The burner assembly for a lamp as claimed in claim 1, wherein two through holes are formed to the outer thread; both two ends of the flexible conductor has a positioning head; the flexible conductor is pushed against a inner wall of the burner with the two positioning heads elastically protruding out from the two through holes respectively.

15. A The burner assembly for a lamp as claimed in claim 1, wherein the other end of the flexible conductor opposite to the positioning head is fixed to an inner wall of the burner by a bolt.

16. A The burner assembly for a lamp as claimed in claim 1, wherein a stopper is formed to the bottom edge of the projection portion for engaging a heat dissipation module.

17. A The burner assembly for a lamp as claimed in claim 16, wherein the stopper serves to be inserted between two fins of the heat dissipation module.
